(19) United States
(12) Patent Application Publication
(10) Pub. No.: US 2011/0135928 A1
(43) Pub. Date: Jun. 9, 2011

(54) METAL SILICON NITRIDE OR METAL SILICON OXYNITRIDE SUBMICRON PHOSPHOR PARTICLES AND METHODS FOR SYNTHESIZING THESE PHOSPHORS

(75) Inventors: Padmanabha R. Ravilisetty, Cupertino, CA (US); Shivkumar Chiruvolu, San Jose, CA (US); Nobuyuki Kambe, Menlo Park, CA (US); Abhishek Jaiswal, Kolkata (IN)

(73) Assignee: NANOGRAM CORPORATION, Milpitas, CA (US)

(21) Appl. No.: 12/883,709

(22) Filed: Sep. 16, 2010

Related U.S. Application Data
(63) Continuation of application No. PCT/US2009/001771, filed on Mar. 20, 2009.
(60) Provisional application No. 61/070,337, filed on Mar. 21, 2008.

(51) Int. Cl. C07F 7/02; C01B 33/00; C09K 11/08; C09K 11/59; B82Y 40/00

(52) U.S. Cl. 428/402; 423/324; 423/327.1; 252/301.4 F; 977/895

(57) ABSTRACT

Submicron powders of metal silicon nitrides and metal silicon oxynitrides are synthesized using nanoscale particles of one or more precursor materials using a solid state reaction. For example, nanoscale powders of silicon nitride are useful precursor powders for the synthesis of metal silicon nitride and metal silicon oxynitride submicron powders. Due to the use of the nanoscale precursor materials for the synthesis of the submicron phosphor powders, the product phosphors can have very high internal quantum efficiencies. The phosphor powders can comprise a suitable dopant activator, such as a rare earth metal element dopant.

### CROSS REFERENCE TO RELATED APPLICATIONS

This application is a continuation of pending international application PCT/US2009/001771 filed Mar. 20, 2009 to Ravilisetty et el., entitled “Metal Silicon Nitride or Metal Silicon Oxynitride Submicron Phosphor Particles and Methods for Synthesizing These Phosphors”, which is incorporated herein by reference, and which claims priority to U.S. provisional patent application 61/070,337 filed on Mar. 21, 2008 to Ravilisetty et al., entitled “Silicon Nitride-Based Submicron Phosphors and Methods for Synthesizing These Phosphors,” incorporated herein by reference.

### FIELD OF THE INVENTION

The invention relates to phosphor particles that are synthesized from submicron particles, such as silicon nitride particles. More specifically, the invention relates to phosphors that are metal silicon nitrides or metal silicon oxynitrides, which may be doped. The invention further relates to thermal reactions to form the phosphor particles.

### BACKGROUND OF THE INVENTION

Phosphors play a significant commercial role with respect to several applications, including, for example, lighting, displays and the like. Phosphors emit light, generally visible light, in response to electrons, electric/magnetic fields or other stimulus. Continuing demands on improved performance, such as a higher resolution at a low cost, place corresponding demands on the materials incorporated into these commercial applications. Nanotechnology offers the promise to improve performance of materials at reasonable costs. A range of phosphor materials have been used or have been proposed with various tradeoffs with respect to performance and practical issues relating to the materials.

Electronic displays often use phosphor materials, which emit visible light in response to interaction with electrons, electromagnetic fields or other energy source. Phosphor materials can be applied to substrates to produce cathode ray tubes, flat panel displays and the like. Improvements in display devices place stringent demands on the phosphor materials, for example, due to decreases in excitation energy or increases in display resolution. For example, electron velocity for phosphor excitation can be reduced in order to reduce power demands. In particular, flat panel displays generally require phosphors that are responsive to low velocity electrons or low voltages.

In addition, a desire for color display requires the use of materials or combinations of materials that emit light at different wavelengths at positions in the display that can be selectively excited. A variety of materials have been used as phosphors. In order to obtain materials that emit at desired wavelengths of light, activators have been doped into phosphor material. Alternatively, multiple phosphors can be mixed to obtain the desired light emission.

### SUMMARY OF THE INVENTION

In a first aspect, the invention pertains to a collection of crystalline metal silicon nitride/oxynitride particle having an average primary particle diameter of no more than about 250 nm and comprising a dopant activator element at no more than about 10 mole percent relative to the total metal plus silicon molar content, wherein the particles have an IQE of at least about 25%.

In some embodiments, the invention pertains to a method for synthesizing metal silicon nitride particles, the method comprising heating a blend of metal nitride precursor particles and silicon nitride precursor particles to form product crystalline metal silicon nitride particles wherein the silicon nitride precursor particles have an average primary particle size of no more than about 100 nm to form product particles having an average primary particle size of no more than about 1 micron.

In additional embodiments, the invention pertains to a method for synthesizing metal aluminum silicon oxynitride particles. The method comprises heating a blend of metal composition precursor particles, aluminum composition precursor particles and silicon composition precursor particles to form product crystalline metal silicon aluminum oxynitride particles. The metal composition precursor particles can comprise a metal oxide, a metal nitride, a metal oxynitride, a metal carbonate or combinations thereof, the aluminum composition precursor particles comprise Al₂O₃, AlN, AlNₓO_{(1-x)3/2} or mixtures thereof, the silicon composition precursor particles comprise Si₃N₄, SiO₂, SiN_{(1-x)4/3}O₂ₓ or mixtures thereof. Furthermore, the silicon composition precursor particles can have an average primary particle size of no more than about 100 nm, and the product metal aluminum silicon oxynitride particles can have an average primary particle diameter of no more than about 1 micron.

In other embodiments, the invention pertains to a method for synthesizing metal silicon nitride/oxynitride particles in which the method comprises heating a blend of metal composition precursor particles and silicon composition precursor particles to form crystalline metal silicon nitride/oxynitride particles. In some embodiments, the silicon composition precursor particles comprise Si₃N₄, SiO₂, SiN_{(1-x)4/3}O₂ₓ, 0<x<1 or mixtures thereof and have an average particle diameter of no more than about 100 nm, and the metal composition precursor particles comprise a metal oxide, a metal nitride, a metal oxynitride, a metal carbonate or combinations thereof and have an average particle diameter of no more than about 100 nm The metal silicon nitride/oxynitride product particles can have an average particle size of no more than about 1 micron.

In further embodiments, the invention pertains to a lighting device comprising a collection of metal silicon nitride particles having an average primary particle size of no more than about 1 micron and in some embodiments no more than about 250 nm.

### BRIEF DESCRIPTION OF THE DRAWINGS

FIG. 1 is a schematic side view of a display device with phosphor materials.

FIG. 2 is a representative x-ray diffractogram for (Sr_{0.98}Eu_{0.02})₂Si₅N₈ synthesized according to a method presented in Example 1.

FIG. 3 a representative x-ray diffractogram for (Ba_{0.95}Eu_{0.05})₂Si₅N₈ synthesized according to a method presented in Example 1.

FIG. 4 is a transmission electron micrograph for (Sr_{0.98}Eu_{0.02})₂Si₅N₈ synthesized according to a method presented in Example 1.

FIG. 5 is a scanning electron micrograph for (Sr_{0.98}Eu_{0.02})₂Si₅N₈ synthesized according to a method presented in Example 1.

FIG. 6 is emission spectra of samples with the compositions Ba₂Si₅N₈:Eu and Sr₂Si₅N₈:Eu synthesized according to a method presented in Example 1 compared with commercial sample of yttrium aluminum garnet phosphor, YAG.

FIG. 7 is emission spectra for samples SiON-21, SiON-32, SiON-34 in comparison to commercially available phosphor YAG-KO (Kasei Optonix).

FIG. 8 is a representative x-ray diffractogram for Ca_{0.94}Eu_{0.1}Al₃Si₉ON₁₅ synthesized according to a method presented in Example 3.

FIG. 9 is a scanning electron micrograph from same sample group Ca_{0.94}Eu_{0.06}Al₃Si₉ON₁₅ synthesized according to a method presented in Example 3.

FIG. 10 is an emission spectrum recorded from one of phosphor samples from the same group Ca_{0.94}Eu_{0.06}Al₃Si₉ON₁₅ synthesized according to a method presented in Example 3.

### DETAILED DESCRIPTION OF THE INVENTION

Nanoscale silicon composition precursor particles and/or nanoscale metal composition precursor particles can be used to synthesize submicron metal silicon nitride particles or metal silicon oxynitride particles. The product submicron metal silicon nitride particles and metal silicon oxynitride particles generally can be formed without the use of high shear milling, and phosphor particles can be produced with high luminosity that can be expressed in terms of intrinsic quantum efficiency. Due to the high luminosity, the submicron metal silicon nitride particles can provide useful phosphors for display and lighting applications. Generally, one or more of the precursor powders can have an average primary particle size of no more than about 100 nm. The precursor powders can be blended and reacted in a solid state reaction. For example, silicon nitride (Si₃N₄) nanoparticles generally can be combined with a metal nitride powders, metal oxynitride powders, metal oxide powders, silicon oxide powders or combinations thereof for thermal processing into the selected phosphor particles, which are generally crystalline. The product particles can have a submicron average particle size. The particles can include a dopant metal element, for example, as an activator. The product phosphor particles are suitable for use in a range of display applications. The use of nanoscale silicon nitride particles and/or other nanoscale particles to synthesize the desired phosphor particles provides desirable starting materials for the synthesis of the submicron phosphors with desirable phosphor properties.

Phosphors generally comprise a host crystal or matrix and a relatively small amount of activator as a dopant. Generally, transition metal ions, e.g., heavy metal ions, or rare earth ions are used as activators. The phosphor particles of interest exhibit luminescence through fluorescence or phosphorescence following excitation with fields, electrons or energetic light or other stimulus. The compositions of particular interest are metal silicon nitride or metal silicon oxynitride composition, which can have suitable activator dopants. Suitable control of crystallinity, particle size, dopant levels and lattice structure can be significant for obtaining high luminosities. The submicron particle sizes described herein can yield high luminescence while providing for desirable processing properties for incorporation into selected products. The phosphor powders should show sufficient luminescence for the desired application.

Submicron metal oxide phosphor particles have been synthesized using laser pyrolysis. In particular, metal/metalloid oxide particles with rare earth metals or rare earth metal dopant/activator are described further in U.S. Pat. No. 6,692,660 to Kumar, entitled “High Luminescent Phosphor Particles and Related Particle Compositions,” incorporated herein by reference. Highly crystalline submicron metal oxide phosphors are described further in published U.S. patent application 2007/0215837A to Chiruvolu et al., entitled “Highly Crystalline Nanoscale Phosphor Particles and Composite Materials Incorporating the Particles,” incorporated herein by reference.

Inorganic particles generally comprise metal and/or metalloid elements in their elemental form or in compounds. Following conventional notation, the expression “metal and/or metalloid” is written as “metal/metalloid” as a short hand notation. In general, inorganic particles can comprise, for example, elemental metal or elemental metalloid, i.e. un-ionized elements, alloys thereof, metal/metalloid oxides, metal/metalloid nitrides, metal/metalloid carbides, metal/metalloid sulfides, metal/metalloid silicates, metal/metalloid phosphates or combinations thereof. Metalloids are elements that exhibit chemical properties intermediate between or inclusive of metals and nonmetals. Metalloid elements include silicon, boron, arsenic, germanium, and tellurium. When the terms metal or metalloid are used without qualification, these terms refer to a metal or metalloid element in any oxidation state, e.g., in elemental form or in a composition. When a metal or metalloid composition is recited, this refers to any composition with one or more metal metalloid elements in non-elemental, i.e., oxidized, form with corresponding additional elements to provide electrical neutrality.

In general, a wide range of metal silicon nitride compositions can be suitable as phosphor powders. A generic formula for these compositions can be represented as MₓSi_{y}N_{z}:Rᵣ, where M represents one or more metal elements, Si is silicon, N is nitrogen, R represents one or more dopant elements, and x, y, z and r indicate the stoichiometry and dopant levels. Similarly, a wide range of metal silicon oxynitride compositions can be used as useful phosphors. A generic formula for the oxynitride compositions can be represented as MₓSi_{y}O_{w}N_{z}:Rᵣ, where M represents one or more metal elements, Si is silicon, O is oxygen, N is nitrogen, R represents one or more dopant elements, and x, y, w, z and r indicate the stoichiometry and dopant levels. For example, in some embodiments, suitable phosphors can comprise alkali earth and other divalent metal elements.

The metal silicon nitride and oxynitride phosphor compositions described herein can be synthesized using nanoscale silicon nitride particles and/or other nanoscale particles in a solid state reaction. For example, silicon nitride precursor powder can be blended with additional precursor powders that supply the remaining metal/metalloid elements, such as in nitride, oxide or carbonate forms, for the desired phosphor composition. One or more of the metal or metalloid elements can be an activator dopant element. If the target composition is an oxynitride, the amount of oxygen introduced with the precursors generally should be controlled to provide only the amount of oxygen desired for the final product material, although performing the processing steps in a nitrogen environment can result in the replacement of some or all of the oxygen.

The nanoscale precursor particles can be synthesized, for example, using flow based approaches. In particular, silicon nitride nanoscale particles and metal nitride submicron particles can be synthesized by laser pyrolysis, although alternative sources may also be available for some materials. Laser pyrolysis can be used to synthesize amorphous or crystalline Si₃N₄. Laser pyrolysis can also be used to synthesize amorphous SiO₂, which can be used as a precursor for the formation of oxynitride phosphors. In general, laser pyrolysis has been successfully used for the synthesis of a wide range of compositions. By appropriately selecting the composition in the reactant stream and the processing conditions, submicron or nanoscale particles incorporating the desired metal/metalloid composition stoichiometry.

In general, in the processes described herein, at least one of the precursor compositions has the form of nanoscale particles, e.g., nanoscale silicon nitride (Si₃N₄) particles. However, in some embodiments it is desirable to mix a plurality of nanoscale powders with different compositions for the solid state reaction process. For example, nanoscale Si₃N₄ and/or SiO₂ can be combined with other metal compositions to form the desired metal silicon nitride or metal silicon oxynitride composition, which can be formed with desirable submicron average particle sizes. The use of a plurality of nanoscale powders in the synthesis process can facilitate the synthesis process with somewhat lower reaction temperatures or times and/or with the achievement of a high degree of crystallinity and chemical homogeneity. If the as synthesized particles have essentially the desired average particle sizes, the powders may be subjected to a reduced time of milling, to a reduced degree of milling or to no milling to obtain the desired submicron product particles. High shear milling has been observed in some systems to adversely alter the crystallinity of powders, which can degrade the phosphor performance. Thus, the reduction or elimination of milling can lead to improved product materials as well as a reduction in production costs. Some low energy or short time milling may be desirable to disperse weak particle agglomerates.

The dopant element(s) can be introduced using a suitable dopant precursor powder, such as a metal oxide, that is incorporated into the solid state reaction so that the dopant element is incorporated into the product particles. So assuming that the quantum efficiency is constant, the dopant level can directly relate to the luminescent properties of the particles. In some embodiments, additional dopant results in greater luminescence since the dopant forms absorption-emission centers within the particles. In general, the luminescence increases with dopant level as more electrons are available for promotion into emitting states. However, quantum efficiency is a complex function of dopant level. Thus, luminosity generally reaches a peak as a function of dopant concentration due to a balance of factors. In particular, luminescent properties depend on the crystallinity of the particle, the positioning of the dopant within the crystal lattice and the concentration. As the dopant level increases, quenching mechanisms come into play that decrease the luminescence, and there is an increase in crystal defects. Thus, at high enough dopant concentrations, the luminosity generally decreases with increasing dopant levels since the quenching begins to dominate over the increase from higher absorption. Thus, the luminosity can have a peak as a function of dopant concentration, although the dopant dependence of the luminosity also depends on the processing parameters so that the relationships can be more complex. With a heat treatment to form the phosphor particles without the use of high shear or other high energy milling, high levels of crystallinity with good dopant incorporation and corresponding high values of quantum yield can be achieved using nanoparticle precursors.

With highly crystalline inorganic phosphor particles, the resulting phosphor particles can have high luminosity. Specifically, the particles can have an internal quantum efficiency of at least about 25%. The average size of the particles, the dopant concentration and the dopant composition can influence the absorption spectrum and the emission spectrum. The higher luminescent-quantum yield properties of the inorganic phosphor particles described herein provide for more efficient operation of devices generally based on any luminescence principle.

The solid state reaction of the blended precursor powders results in the formation of the metal silicon nitride or metal silicon oxynitride. The conditions of the reaction can be selected to result in an appropriate crystallinity for the product material. For the formation of the oxynitride phosphors, it can be desirable to use two heat steps or firing in which in the first step an intermediate silicate compound is synthesized which is amenable to convert to the desired crystalline structure during the second firing. The processes described herein for particle synthesis can be performed at relatively low temperatures. Through the use of at least some nanoscale precursor materials along with appropriate processing conditions, submicron product phosphors can be produced. The product powders display appropriate emission properties and corresponding quantum efficiencies.

The product powders can be milled or otherwise processed to synthesize the product material with desired particle properties, although in some embodiments it may be desirable to avoid milling. The milling can be performed in a bead mill or the like. Suitable mills are commercially available. In some embodiments, milling can be performed in the presence of a liquid. In some embodiments, it is desirable to mill the particles at low shear and/or low energy to avoid damaging the crystalline structure of the particles, which can result in significant decreases in luminescence of the particles. The submicron silicon nitride-based phosphors can be useful in a range of display applications. Alternatively or additionally, low energy mixing, or low energy ultrasonic disruption can be used to disperse weakly agglomerated particles.

The product submicron phosphor particles can be used to form small structures, such as display pixels, due to their small particle size. Also, submicron phosphors can have high luminescence. Display devices comprising nanoparticles with good size uniformity are described further in U.S. Pat. No. 7,132,783 to Kambe et al., entitled “Phosphor Particles Having Specific Distribution of Average Diameters,” incorporated herein by reference. The small particle size and relatively high luminosity provide the ability for improved device formation and more efficient operation. High luminescence provides for the use of lower amounts of phosphors for a cost savings in materials.

Generally, the phosphor particles can be incorporated into a range of display and/or illumination devices, such as light emitting diode (LED) devices, cathode ray tubes, plasma display panels, filed emission devices and electroluminescent devices. Similarly, the phosphors can be useful in solid state lighting devices. The particular composition of the phosphors can be selected to yield a desired emission from the phosphor. In some embodiments, red emitting phosphor particles can be incorporated into solid state light emitting devices which emit photons in the blue or near ultraviolet portion of the spectrum as an excitation source for the red phosphors.

### Phosphor Particle Properties and Compositions

The particular composition and activator concentration can be selected to achieve a desired emission spectrum from the phosphor. In some embodiments, the product nitride based phosphors are desirable as red phosphors, although the compositions can be selected for significant emissions in other portions of the visible and infrared spectrum. In general the product phosphor particles can comprise metal silicon nitrides or metal silicon oxynitrides in which the phosphor particles comprise a selected activator dopant. The particles can have very high luminosities as evaluated in terms of intrinsic quantum yields due to the desirable processing approaches described herein to form submicron phosphor particles.

With respect to metal silicon nitride phosphors, the compositions generally have a composition MₓSi_{y}N_{z}:Rᵣ, where M represents one or more metals, Si is silicon, N is nitrogen, R represents one or more dopant metals, and x, y, z and r indicate the stoichiometry and level of dopant. The value of r is generally in the range 0.0001≦r≦0.5 and in further embodiments 0.0001≦r≦0.1 as a factor relative to x+y. These ranges of dopant levels can be applied herein to compounds in which no other amounts are specifically applied with respect to the dopant level in the phosphor composition. Since N has a valence of −3 and Si has a valence of +4, x=(3z−4y−Wr)/Q, where W is the valence of R and Q is the valence of M. This formula can be straightforwardly adjusted by a person of ordinary skill in the art for embodiments in which M and/or R involve a plurality of metals.

Alkaline earth silicon nitride compositions are useful phosphor compositions for light emissions in desirable portions of the visible spectrum. For example, red phosphors can have the composition MₓSi_{y}N_{((2/3)x+(4/3)y)}:R, where M is a group II element, i.e., Mg, Ca, Sr, Ba, Zn or combinations thereof, Si is silicon, and R is a rare earth activation element, e.g., Y, La, Ce, Pr, Nd, Sm, Eu, Gd, Tb, Dy, Ho, Er, Lu and combinations thereof, in which some embodiments of the composition have 0.5≦x≦3 and 1.5≦y≦8. For example, specific compositions of interest include the stoichiometry M₂Si₅N₈:R These red phosphors are described further in U.S. Pat. No. 7,297,293 to Tamaki et al., entitled “Nitride Phosphor and Production Process Thereof, and Light Emitting Device,” incorporated herein by reference.

Lanthanide silicon nitrides are described further in published U.S. patent application 2006/0017041A to Tian et al, entitled “Nitride Phosphors and Devices,” incorporated herein by reference. These lanthanide silicon nitrides have the formula Ln₂Si₃N₄:R, where Ln is a trivalent lanthanide or combination thereof. In some embodiments the nitride phosphors have a formula M_{1-z}LSiN₃:Rᵣ, in which M is a divalent element, such as calcium, manganese, strontium, barium, zinc, beryllium, cadmium, mercury or combinations thereof, L is a trivalent element, such as boron, aluminum, gallium, indium, thallium, yttrium, scandium, phosphorous, arsenic, antimony, bismuth, or combinations thereof, Si is silicon, N is nitrogen, R is an activator element or elements, such as a rare earth element, transition metal element or combinations thereof and r is generally in the range 0.0001≦r≦0.5 and in further embodiments 0.0001≦r≦0.1. These compositions are described further in U.S. Pat. No. 7,252,788 to Nagatomi et al., entitled “Phosphor Light Source and LED,” incorporated herein by reference. Additional nitride phosphors can have the formula M_{1-z}L₂Si₄N₈:Rᵣ and M_{2-z}Si₅N₈:Rᵣ, in which M is a divalent element, L is a trivalent element, R is an activator dopant metal element and r is generally in the range 0.0001≦r≦0.5 and in further embodiments 0.0001≦r≦0.1, with specific examples of M and L given above.

With respect to metal silicon oxynitride phosphors, the compositions generally have a composition MₓSi_{y}N_{z}O_{w}:Rᵣ, where M represents one or more metals, Si is silicon, N is nitrogen, O is oxygen, R represents one or more dopant metals, and w, x, y, z and r indicate the stoichiometry and level of dopant. The value of r is generally in the range 0.0001≦r≦0.5 and in further embodiments 0.0001≦r≦0.1. Since N has a valence of −3, O has a valence of −2 and Si has a valence of +4, x=(3z+2w−4y−Wr)/Q, where W is the valence of R and Q is the valence of M. This formula can be straightforwardly adjusted by a person of ordinary skill in the art for embodiments in which M and/or R involve a plurality of metals.

In some embodiments, metal silicon oxynitride phosphors can be formed with divalent metal elements. Specifically, phosphors with the formula MₓSi₃O_{y}N_{z}:R, where M is a divalent metal, R is an activator metal, 0<x<15, 0<y<30, and 2<z<6, is described in U.S. Pat. No. 7,291,289 to Gotoh et al., entitled “Phosphor and Production Method of the Same and Light Source and LED Using the Phosphor,” incorporated herein by reference. Examples of divalent elements suitable as M include, for example, Be, Mg, Ca, Sr, Ba, Zn, Cd, Hg and combinations thereof. R generally can be a rare earth metal element, a transition metal element or a combination thereof. In general, the phosphor comprises R in the formula molar range of 0.0001≦r≦0.5 and in further embodiments 0.0001≦r≦0.1. Other silicon oxynitride phosphors based on divalent metals can have a formula (Sr_{1-x-y}Ba_{y}Caₓ)_{1-c}Si₂O₂N₂:Eu_{c}, where 0<x+y<0.5.

A more general silicon oxynitide phosphor composition is described in U.S. Pat. No. 7,297,293 to Tamaki et al., entitled “Nitride Phosphor and Production Process Thereof, and Light Emitting Device,” incorporated herein by reference. Suitable metal silicon oxynitride compositions can have the formula MₓSi_{y}O_{z}N_{(2/3)x+(4/3)y-(2/3)z}:R, in which M is a divalent element, such as Mg, Ca, Sr, Ba, Zn and combinations thereof, Si is silicon, R is a rare earth element and R is generally present with a formula molar amount no more than about 0.5 relative to x and in further embodiments no more than about 0.1 relative to x. In some embodiments, the parameters are approximately in the ranges 0.5≦x≦3, 1.5≦y≦8, and 0<z≦3. Lanthanum silicon oxynitrides and silicon aluminum boron oxynitrides are discussed further in published U.S. patent application 2006/0017041 to Tian et al., entitled Nitride Phosphors and Devices, incorporated herein by reference.

Silicon aluminum oxynitrides, generally referred to as SiAlON; have generated a considerable interest as phosphors. Activated SiAlON phosphors are described further in published U.S. patent application 2005/0285506 to Sakuma et al., entitled Oxynitride Phosphor and a Light Emitting Device,” incorporated herein by reference. In particular, one class of SiAlONs of significance have a formula Mₓ(Si,Al)₁₂(O,N)₁₆:Eu_{y}, in which M is a divalent metal, x is in the approximate range of 0.3<x<1.5 and y is in the approximate range of 0.001<y<0.8 and where Eu can be partially or completely substituted with another rare earth element. (Si,Al)₁₂ refers to SiₐAl_{b}, in which a+b=12, and (O,N)₁₆ refers to O_{c}N_{d} with c+d=16. In some embodiments, b is approximately in the range 0.3<b<6.75, and c is in the approximate range 0<c<2.5.

The internal quantum efficiency (IQE) of particles can be measured as the number of photons emitted divided by the number of photons absorbed. With the submicron/nanoscale phosphor particles described herein, the IQE can be at least about 25%, in further embodiments at least about 35%, in other embodiments at least about 40%, in additional embodiments at least about 45% and in other embodiments from about 50% to about 75%. A person or ordinary skill in the art will recognize that additional ranges of quantum efficiency within the explicit ranges are contemplated and are within the present disclosure.

By definition, the internal quantum efficiency can be evaluated using the following expression

$$η = \frac{{N}_{E}}{{N}_{I} - {N}_{R}} \qquad ( 1 )$$

Here N_{I}, N_{E}, and N_{R} is the number of photons in the spectrum of the incident, emitted and reflected light, respectively. These values are measured with a spectrophotometer that should be calibrated using a standard light source. Then, if the radiance of the standard source is given in units of W/nm/cm²/sr, the quantum efficiency can be expressed as

$$η = \frac{\int λ E ( λ ) d λ}{\int λ [ I ( λ ) - R ( λ ) ] d λ} , \qquad ( 2 )$$

where I(λ), E(λ), and R(λ) is the spectrum of the incident, emitted and reflected light, respectively. If the radiance of the standard source is already given in units of photons/nm/cm²/sr, the factor of 2, under the integrals in Eq. (2) should be omitted.

The measurement procedure using an integrating sphere coupled to a spectrophotometer is justified in the paper by J. C. de Mello, H. F. Wittmann, and R. H. Friend “An improved experimental determination of external photoluminescence quantum effect”, Adv. Mater. 9, 230 (1997). Three measurements are needed:
1. The laser (or another exciting source) is shined into the empty sphere
2. The sample is put in the sphere, but the laser is directed onto the wall
3. The sample is put in the sphere and the laser is illuminated the sample in the normal direction.
   From the collected spectra, the laser spectra and emission spectra are deconvolved and integrated. Then, the quantum efficiency is computed as

$$η = \frac{{E}_{3} {L}_{2} - {E}_{2} {L}_{3}}{{L}_{1} ( {L}_{2} - {L}_{3} )} \qquad ( 3 )$$

where, L corresponds to the integrated laser spectra and E corresponds to the integrated emission spectra. Integrating spheres are commercially available for use with UV-visible spectrometers. A similar approach for the measurement of internal quantum efficiency is described in U.S. Pat. No. 7,001,537 to Kijima et al., entitled “Phosphor and its Production Process,” incorporated herein by reference. This method is applicable to film materials. Integrating spheres are commercially available for use with UV-visible spectrophotometers.

An approach for the measurement of internal quantum efficiency described in U.S. Pat. No. 7,001,537 to Kijima et al., entitled “Phosphor and its Production Process,” incorporated herein by reference, can be used for a direct measurement of internal quantum efficiency from powdered samples. At first, a white diffusion standard having a reflectance of 0.98 is placed in an integrating sphere and is illuminated with a light source as the incident angle of about 5 to 10 degrees. The spectrum of the light reflected from the standard is collected by a spectra-radiometer coupled with the sphere. The integral over this spectrum can be referred to as I.

Then, the standard is replaced with a sample, which can be a powder pressed into a pellet. The sample is illuminated with the light source using the same geometry as the standard. The spectrum of the sample is collected with the spectra-radiometer connected with the integration sphere. The spectrum of the sample is deconvoluted into a reflection spectrum and an emission spectrum. Generally, the deconvolution is based on assigning a cutoff where wavelengths above the cutoff are considered emission while wavelengths below the cutoff are considered reflection. Both the reflection spectrum and the emission spectrum are integrated. The integral over the reflection region can be called R, and the spectrum over the emission region can be called E.

These spectra are collected from the sphere walls. In order to relate them to the actual quantities on the sample surface, the integrating sphere properties, such as a multiplier factor and port sizes, should be considered. They can be described with empirical constants Z₁ and Z₂. For a precise determination of the quantum efficiency, the additional contribution to the sample illumination caused by the reflected light which is scattered back by the walls of the integrating sphere should be taken into account.

Then, the internal quantum efficiency (IQE) can be expressed as:

$$η = \frac{\frac{E}{{Z}_{1}}}{\frac{I / 0.98 - R}{{Z}_{2}} + R} \qquad ( 4 )$$

Correspondingly, the external quantum efficiency (EQE), which is the ratio of the number of photons in the spectrum of the emitted light over the incident light, can be evaluated as:

$$μ = \frac{\frac{E}{{Z}_{1}}}{\frac{I / 0.98}{{Z}_{2}} + R} \qquad ( 5 )$$

### Nanoscale Precursor Particles

Processes herein for the synthesis of submicron phosphor particles generally can involve the use of one or more types of precursor particles having a nanoscale particle size, i.e., an average primary particle size of no more than about 100 nm. Suitable nanoparticles can be formed, for example, by laser pyrolysis, flame synthesis, combustion, or solution-based processes, such as sol gel approaches. Selection of a suitable approach may depend on the composition of the selected precursor particles. In particular, flow-based processes, such as laser pyrolysis or flame spray pyrolysis, have been successfully used for the synthesis of uniform nanoscale particles. Laser pyrolysis involves light from an intense light source that drives the reaction to form the particles. Laser pyrolysis is an excellent approach for efficiently producing a wide range of nanoscale particles with a selected composition and a narrow distribution of average particle diameters. Alternatively, submicron particles can be produced using a flame production apparatus such as the apparatus described in U.S. Pat. No. 5,447,708 to Helble et al., entitled “Apparatus for Producing Nanoscale Ceramic Particles,” incorporated herein by reference. Furthermore, submicron particles can be produced with a thermal reaction chamber such as the apparatus described in U.S. Pat. No. 4,842,832 to Inoue et al., “Ultrafine Spherical Particles of Metal Oxide and a Method for the Production Thereof,” incorporated herein by reference.

A basic feature of the application of a flow based process for the production of metal/metalloid nitride, oxide or oxynitride is the introduction of the desired metal/metalloid precursors into the reactant flow. Also, a nitrogen source, an oxygen source or both is also introduced into the reactant flow. Flame spray pyrolysis generally can be used to synthesize submicron particles of a selected metal/metalloid oxide composition. Laser pyrolysis can be used to synthesize a large range of selected submicron powders of metal/metalloid oxide, metal/metalloid nitride or metal/metalloid oxynitride compositions.

In flame spray pyrolysis, an aerosol of a liquid precursor and a liquid fuel are delivered into a reaction chamber where the fuel is combusted in an oxygen atmosphere to form the product metal/metalloid oxide particles. The particles are harvested from the flow using an appropriate filter or other collector. Generally, the reactor is open to the ambient atmosphere. All or a portion of the oxygen for the reaction can be provided by drawing air into the reactor. The pyrolysis precursor can comprise metal and/or metalloid compositions that can be dissolved into a liquid that is delivered from the aerosol delivery system. Flame spray pyrolysis for the production of metal oxides is described further in U.S. Pat. No. 5,958,361 to Laine et al., entitled “Ultrafine Metal Oxide Powders by Flame Spray Pyrolysis,” incorporated herein by reference. Versatile precursor solutions, such as aqueous based precursor solutions, for flame spray pyrolysis synthesis of metal/metalloid oxides are described further in copending U.S. patent application filed on Oct. 24, 2008 with a Ser. No. 12/288,890 to Jaiswal et al., entitled “Flame Spray Pyrolysis With Versatile Precursors For Metal Oxide Nanoparticle Synthesis and Applications of Submicron Inorganic Oxide Compositions for Transparent Electrodes,” incorporated herein by reference.

Laser pyrolysis is a desirable approach to form highly uniform nanoparticles. In laser pyrolysis, light from an intense light source drives the reaction to form the particles. Laser pyrolysis is a particularly versatile particle synthesis approach that has been used successfully for the synthesis of a wide range of inorganic particles, including, for example, compositions with multiple metal/metalloid elements as well as doped materials.

For convenience, light-based pyrolysis is referred to as laser pyrolysis since this terminology reflects the convenience of lasers as a radiation source and is a conventional term in the art. Laser pyrolysis approaches can incorporate a reactant flow that can involve gases, vapors, aerosols or combinations thereof to introduce desired elements into the flow stream. The versatility of generating a reactant stream with gases, vapor and/or aerosol precursors provides for the generation of particles with a wide range of potential compositions.

A basic feature of successful application of laser pyrolysis for the production of desirable inorganic nanoparticles is the generation of a reactant stream containing one or more metal/metalloid precursor compounds, a radiation absorber and, in some embodiments, a secondary reactant. The secondary reactant can be a source of non-metal/metalloid atoms, such as nitrogen or oxygen, which are introduced for incorporation into the desired product and/or can be an oxidizing or reducing agent to drive a desired product formation. A secondary reactant may not be used if the precursor decomposes to the desired product under intense light radiation. Similarly, a separate radiation absorber may not be used if the metal/metalloid precursor and/or the secondary reactant absorb the appropriate light radiation to drive the reaction.

In laser pyrolysis, the reaction of the reactant stream is driven by an intense radiation beam, such as a light beam, e.g., a laser beam. In some embodiments, CO₂ lasers can be effectively used. As the reactant stream leaves the radiation beam, the inorganic particles are rapidly quenched with particles in present in the resulting product particle stream, which is a continuation of the reactant stream. The concept of a stream has its conventional meaning of a flow originating from one location and ending at another location with movement of mass between the two points, as distinguished from movement in a mixing configuration.

A laser pyrolysis apparatus suitable for the production of commercial quantities of particles by laser pyrolysis has been developed using a reactant inlet that is significantly elongated in a direction along the path of the laser beam. This high capacity laser pyrolysis apparatus, e.g., 1 kilogram or more per hour, is described in U.S. Pat. No. 5,958,348, entitled “Efficient Production Of Particles By Chemical Reaction,” incorporated herein by reference. Approaches for the delivery of aerosol precursors for commercial production of particles by laser pyrolysis is described in copending and commonly assigned U.S. Pat. No. 6,193,936 to Gardner et al., entitled “Reactant Delivery Apparatus,” incorporated herein by reference, as well as copending U.S. patent application Ser. No. 12/233,325 to Frey et al., entitled Uniform Aerosol Delivery for Flow-Based Pyrolysis for Inorganic Material Synthesis,” incorporated herein by reference.

A wide range of simple and complex submicron and/or nanoscale particles have been produced by laser pyrolysis with or without additional heat processing. In general, the inorganic particles generally comprise metal or metalloid elements in their elemental form or in compounds. Specifically, the inorganic particles can include, for example, elemental metal or elemental metalloid, i.e. un-ionized elements such as silver or silicon, metal/metalloid oxides, metal/metalloid nitrides, metal/metalloid carbides, metal/metalloid sulfides or combinations thereof. In addition, uniformity of these high quality materials can be substantial. These particles generally can have a very narrow particle size distribution.

Several different types of nanoscale particles have been produced by laser pyrolysis. Selected inorganic particles can generally be characterized as comprising a composition with a number of different elements that are present in varying relative proportions, where the number and the relative proportions are selected based on the application for the nanoscale particles. Materials that have been produced (possibly with additional processing, such as a heat treatment) or have been described in detail for production by laser pyrolysis include, for example, carbon particles, silicon, SiO₂, doped SiO₂, titanium oxide (anatase and rutile TiO₂), MnO, Mn₂O₃, Mn₃O₄, Mn₅O₈, vanadium oxide, silver vanadium oxide, lithium manganese oxide, aluminum oxide (γ-Al₂O₃, delta-Al₂O₃ and theta-Al₂O₃), doped-aluminum oxide (alumina), tin oxide, zinc oxide, rare earth metal oxide particles, rare earth doped metal/metalloid nitride particles, rare earth metal/metalloid sulfides, rare earth doped metal/metalloid sulfides, silver metal, iron, iron oxide, iron carbide, iron sulfide (Fe₁₋ₓS), cerium oxide, zirconium oxide, barium titanate (BaTiO₃), aluminum silicate, aluminum titanate, silicon carbide, silicon nitride, and metal/metalloid compounds with complex anions, for example, phosphates, silicates and sulfates. The production of a wide range of particles by laser pyrolysis is described further in U.S. Pat. No. 7,384,680 to Bi et al., entitled “Nanoparticle Production and Corresponding Structures,” incorporated herein by reference.

The production of silicon oxide nanoparticles is described in U.S. Pat. No. 6,726,990 to Kumar et al., entitled “Silicon Oxide Particles,” incorporated herein by reference. This patent describes the production of amorphous SiO₂. The synthesis by laser pyrolysis of silicon carbide and silicon nitride is described in published PCT patent application WO 01/32799A to Reitz et al., entitled “Particle Dispersions,” incorporated herein by reference. The production of silicon particles by laser pyrolysis is described in an article by Cannon et al., J. of the American Ceramic Society, Vol. 65, No. 7, pp. 330-335 (1982), entitled Sinterable Ceramic Particles From Laser-Driven Reactions: II, Powder Characteristics And Process Variables,” incorporated herein by reference.

As noted above, the laser pyrolysis synthesis of silicon nitride has been described, which was based on using laser pyrolysis with SiH₄ and NH₃ precursors. A similar process is used to synthesize silicon nitride nanoscale powders described in the examples below. Desired metal nitride nanoscale powders can be similarly synthesized. For example, the precursor flow can comprise the desired metal elements, which can be supplied generally in the forms described in the references noted above. The nitrogen can be supplied using NH₃, N₂, other nitrogen compounds or combinations thereof.

In some embodiments, collection of nanoscale precursor particles may have an average diameter for the primary particles of less than about 100 nm, in some embodiments from about 2 nm to about 75 nm, in further embodiments from about 2 nm to about 50 nm and in additional embodiments from about 2 nm to about 25 nm. A person of ordinary skill in the art will recognize that other ranges within these specific ranges are covered by the disclosure herein. Primary particle diameters are evaluated by transmission electron microscopy.

As used herein, the term “particles” refer to physical particles, which cannot be further broken down by ultrasonic agitation in a liquid i.e. physical particles are not held together by fairly weak surface forces. Therefore, particles refer to primary (unfused) particles and hard agglomerates which consist of primary particles that are chemical bonded by solid bridges. For particles formed by laser pyrolysis, the particles can be generally effectively the same as the primary particles, i.e., the primary structural element within the material. If there is hard fusing of some primary particles, these hard fused primary particles form correspondingly larger physical particles. The primary particles can have a roughly spherical gross appearance, or they can have rod shapes, plate shapes or other non-spherical shapes. Upon closer examination, crystalline particles generally have facets corresponding to the underlying crystal lattice. Amorphous particles generally have a spherical aspect. Diameter measurements on particles with asymmetries are based on an average of length measurements along the principle axes of the particle.

Because of their small size, the particles tend to form loose agglomerates due to van der Waals and other electromagnetic forces between nearby particles. These loose agglomerates can be dispersed in a dispersant to a significant degree, and in some embodiments approximately completely to form dispersed primary particles. The size of the dispersed particles can be referred to as the secondary particle size. The primary particle size, of course, is the lower limit of the secondary particle size for a particular collection of particles, so that the average secondary particle size can be approximately the average primary particle size if the primary particles are substantially unfused and if the particles are effectively completely dispersed in the liquid. The secondary or agglomerated particle size may depend on the subsequent processing of the particles following their initial formation and the composition and structure of the particles.

Even though the particles may form loose agglomerates, the nanometer scale of the particles, as well as the primary particles, is clearly observable in transmission electron micrographs of the particles. The particles generally have a surface area corresponding to particles on a nanometer scale as observed in the micrographs. Furthermore, the particles can manifest unique properties due to their small size and large surface area per weight of material. For example, the absorption spectrum of crystalline, nanoscale TiO₂ particles is shifted into the ultraviolet.

The particles can have a high degree of uniformity in size. Laser pyrolysis generally results in particles having a very narrow range of particle diameters. Furthermore, heat processing under suitably mild conditions generally does not significantly alter the very narrow range of particle diameters. With aerosol delivery of reactants for laser pyrolysis, the distribution of particle diameters is particularly sensitive to the reaction conditions. Nevertheless, if the reaction conditions are properly controlled, a very narrow distribution of particle diameters can be obtained with an aerosol delivery system. As determined from examination of transmission electron micrographs, the primary particles generally have a distribution in sizes such that at least about 95 percent, and in some embodiments 99 percent, of the particles have a diameter greater than about 35 percent of the average diameter and less than about 220 percent of the average diameter. In additional embodiments, the primary particles generally have a distribution in sizes such that at least about 95 percent, and in some embodiments 99 percent, of the primary particles have a diameter greater than about 40 percent of the average diameter and less than about 160 percent of the average diameter. In some embodiments, the primary particles have a distribution of diameters such that at least about 95 percent, and in some embodiments 99 percent, of the primary particles have a diameter greater than about 60 percent of the average diameter and less than about 140 percent of the average diameter. A person of ordinary skill in the art will recognize that other ranges of uniformity within these specific ranges are covered by the disclosure herein. In some embodiments, the particles can have distributions within the parameters ranges above for the primary particles.

Furthermore, in some embodiments essentially no primary particles have an average diameter greater than about 10 times the average diameter, in other embodiments about 6 times the average diameter, in further embodiments 5 times the average diameter, and in additional embodiments 3 times the average diameter. In other words, the primary particle size distribution effectively does not have a tail indicative of a small number of primary particles with significantly larger sizes. This is a result of the small reaction region to form the inorganic particles and corresponding rapid quench of the inorganic particles. In some embodiments, the particles can have a cut off in the tail of the particle size distribution within the ranges specified above for the primary particles. An effective cut off in the tail of the size distribution indicates that there are less than about 1 particle in 10⁶ have a diameter greater than a specified cut off value above the average diameter. High particle uniformity can be exploited in a variety of applications.

In addition, the precursor nanoparticles for incorporation may have a very high purity level. Furthermore, crystalline nanoparticles, such as those produced by laser pyrolysis, can have a high degree of crystallinity. Similarly, the crystalline nanoparticles produced by laser pyrolysis can be subsequently heat processed to improve and/or modify the degree of crystallinity and/or the particular crystal structure. Impurities on the surface of the particles may be removed by heating the particles to achieve not only high crystalline purity but high purity overall.

### Synthesis Processes for Submicron Nitrides and Oxynitrides

The solid state synthesis approach described herein can be based on the use of nanoscale precursor particles, such as silicon nitride with the nominal formula of Si₃N₄, although the synthesis approach can result in silicon rich nitrides. In some embodiments, a plurality of nanoscale precursor materials can be used. For example, one or more silicon-based precursors, such as Si₃N₄ and/or SiO₂, and/or one or more metal-based precursors, such as Al₂O₃, AlN or CaO, with an average particle size of no more than about 100 nm can be combined for a thermal reaction to generate the product nitride or oxynitride composition. In some embodiments, the major components of the product phosphor are introduced as a nanoscale powder for the thermal synthesis reaction. Two heat processing steps can be used in which the first thermal reaction to a significant degree is used to form the desired material with a selected stoichiometry and the second thermal processing step improves the crystallinity of the product phosphor. Through the use of nanoscale starting materials, submicron phosphors particles can be synthesized without the use of a hard milling step to fragment the particles.

In general, any reasonable approach can be used to synthesize or otherwise obtain suitable nanoscale precursor powders. The nanoscale powders comprise a collection of particles with an average primary particle size of no more than about 100 nm. More details of the nanoscale precursor are described in the section above. Similarly, suitable synthesis approaches are described above for the nanoscale precursor particles. In some embodiments, at least one precursor material has an average primary particle size of no more than 100 nm. In additional embodiments, a plurality of different precursor powders has an average primary particle size of no more than about 100 nm. In further embodiments, all of the precursor powders except for one or more precursors introducing a dopant element comprise particles with an average particle size of no more than about 100 nm. In additional embodiments, all of the precursor powders have an average primary particle size of no more than about 100 nm. With respect to any of these embodiments, the precursor particles can have average primary particle sizes from about 2 nm to about 75 nm, alternatively from about 2 nm to about 50 nm, furthermore from about 5 nm to about 25 nm. A person of ordinary skill in the art will recognize that additional ranges within the explicit ranges above are contemplated and are within the present disclosure. In some embodiments, the precursor particle size can have a narrow distribution of particle sizes as specified above for the precursor primary particles.

With respect to nitride phosphors, the phosphor synthesis process can comprise mixing submicron silicon nitride particles with metal nitride particles. In some embodiments, the metal nitride can be an alkali metal nitride, an alkali earth metal nitride, a transition metal nitride or a nitride of Al, Ga, In, Sn, Sb, Tl, Pb, Bi or Po. The particles can be combined using solid state blending prior to performing the solid state reaction, although the particles can be dispersed in a dispersing liquid during their blending in some embodiments. The metal nitride particles generally comprise a blend of particles, such as alkali earth nitride particles or lanthanide nitride particles. Dopants can be introduced as a corresponding oxide and/or nitride since the form of the dopant precursor is less significant due to the small amount, which can be converted to the corresponding nitride during the heating process, i.e., nitridation, in a nitrogen containing environment. After blending, any liquid is removed, for example, using evaporation and/or phase separation.

After mixing the precursor powders, the particle blend is heated generally in a reducing and/or nitrogen containing environment, which can comprise for example, H₂, N₂ or combinations thereof. In particular, a combination of N₂ and no more than about 10 mole percent H₂ and in further embodiments no more than about 4 mole percent H₂ can be used. A person of ordinary skill in the art will recognize that additional ranges of hydrogen content within the explicit ranges above are contemplated and are within the present disclosure. The heating can be performed in a suitable oven, furnace or the like with a controlled atmosphere generally at a temperature of no more than about 1600° C. and in some embodiments, in the range from about 1000° C. to about 1450° C. and in some embodiments, in the range from about 1000° C. to about 1200° C. The heating can be performed for a period of time generally of at least 15 minutes and in further embodiments from about 30 minutes to about 24 hours, and in some embodiments from about 45 minutes to about 10 hours. A person of ordinary skill in the art will recognize that additional ranges of temperature and heating time within the explicit ranges above are contemplated and are within the present disclosure. The heating process and other heating steps described herein can be performed with mixing or stirring to have a more uniform distribution of heat during the heating process. Also, the heat and cooling rates can be adjusted over reasonable values to achieve desired product properties.

For the formation of oxynitride particles, the precursor powders can comprise oxide particles, nitride particles or a combination thereof. For example, it can be desirable to use a blend of silicon nitride and silicon oxide powders along with metal oxide particles, although metal nitride powders can be used in addition and/or as an alternative to the metal oxide powders. One or more of these powders can have an average primary particle size of no more than 100 nm. The relative amounts of silicon nitride and silicon oxide, along with the amounts of metal oxide and metal nitride powders, can be selected to introduce the desired amounts of nitrogen and oxygen into the product powders. In addition, the atmosphere during the processing steps can alter the amounts of nitrogen and oxygen in the product compositions. The selection of the particular compositions for processing may influence the processing of the materials due to possible different reactivity of the materials.

In some embodiments for the formation of oxynitride materials, the heating can be performed in a two step process. In the first step, silicon oxide powder is mixed with metal oxide powders to form a silicate product composition. The heating step can be performed in a reducing atmosphere, such as forming gas with a majority of N₂ with a small amount of H₂ gas. This first step can be performed generally at a temperature of no more than about 1400° C. and in some embodiments, in the range from about 1000° C. to about 1200° C. The heating can be performed for a period of time generally of at least 15 minutes and in further embodiments from about 30 minutes to about 24 hours, and in some embodiments from about 45 minutes to about 10 hours. The resulting silicate powder can be mixed with silicon nitride and/or metal nitride. This second blend can be subjected to a second heating step to form the crystalline oxynitride. A small quantity of flux material, such as ammonium chloride or ammonium fluoride, can be added to improve the morphology and to reduce the reaction temperature. The second heating step generally can be performed at a temperature of no more than about 1600° C. and in some embodiments in the range from about 1100° C. to about 1400° C. The heating can be performed for a period of time generally of at least 15 minutes and in further embodiments from about 30 minutes to about 24 hours, and in some embodiments from about 45 minutes to about 12 hours. A person of ordinary skill in the art will recognize that additional ranges of processing time and processing temperatures are contemplated and are within the present disclosure. A two step processing approach for the formation of oxynitrides is also discussed in Yun et al., J. Electrochemistry Society 154: J320 (2007).

Following the solid state reaction, the product phosphor particles can have a submicron character. In general, the particles can be formed with relatively high levels of crystallinity. It has been found that milling can be significantly detrimental to crystallinity and corresponding luminosity of submicron particles. Therefore, significant amounts of milling are generally undesirable, and in particular it is undesirable to use milling to significantly reduce particle size. The submicron phosphor powders synthesized in the examples below were formed without extensive milling. In particular, ultrasound was used to disperse clusters without applying large amounts of shear to the particles. In general, it has been found desirable to process the final phosphor particles only using low shear and low energy milling or other mixing approaches. The desirability of having high crystallinity submicron phosphor particles is described further in the context of metal oxide phosphors in published U.S. patent application 2007/0215837A to Chiruvolu et al., entitled “Highly Crystalline Nanoscale Phosphor Particles and Composite Materials Incorporating the Same,” incorporated herein by reference. The resulting particles further have a high intrinsic quantum yield as described further above.

### Phosphor Applications

A variety of desirable phosphor particles and their preparation are described in detail herein. The phosphors emit light, such as visible light, following excitation. Some useful phosphors emit light in the infrared portion of the light spectrum. A variety of ways can be used to excite the phosphors, and particular phosphors may be responsive to one or more of the excitation approaches. Particular types of luminescence include, for example, cathodoluminescence, photoluminescence and electroluminescence which, respectively, involve excitation by electrons, light and electric fields. Many materials that are suitable as cathodo-luminescence phosphors are also suitable as electroluminescence phosphors.

In particular, the phosphor particles can be suitable for low-velocity electron excitation, with electrons accelerated with potentials below 1 kilovolts (KV), and more preferably below 100 V. The small size of the particles makes them suitable for low velocity electron excitation. Low energy electron excitation can be used because the correspondingly lower penetration distances of the electrons are less limiting as the particle size decreases.

Furthermore, nanoscale particles can produce high luminescence, for example, with low electron velocity excitation. As the voltages decrease, high luminosity can be expected from small sized particles, although a particle size may be reached beyond which even smaller particle sizes can result in slightly reduced luminosity. The effects of decreasing particle size on phosphors is described theoretically in “The Effects of Particle Size And Surface Recombination Rate on the Brightness of Low-Energy Phosphor,” J. S. Yoo et al., J. App. Phys. 81 (6), 2810-2813 (Mar. 15, 1997), incorporated herein by reference.

Improved phosphor particles can be effectively used in a range of visualization applications. Furthermore, there is a desire to produce more energy efficient general lighting sources. For example, the phosphor particles can be used in displays, vehicle lighting, traffic lights, home lighting, public lighting, signage and other general lighting. The phosphors described herein can be incorporated into fluorescent lighting to create more desired color qualities from the lighting. Also, the phosphors can be incorporated into solid state lighting devices. For example, these lighting devices can comprise an array of light emitting diodes formed on a common semiconductor substrate. Phosphors can be used to shift the diode emissions to a white light emission. Embodiments of a solid state lighting device are described further, for example, in U.S. Pat. No. 7,329,887 to Henson et al., entitled “Solid State Light Device,” incorporated herein by reference. Also, improved phosphors with suitable compositions can be used in x-ray scintillation counters, as described further in U.S. Pat. No. 6,974,955 to Okada et al., entitled “Radiation Detection Device and System, and Scintillator Panel Provided to the Same,” incorporated herein by reference.

The phosphor particles can be used to produce any of a variety of display devices. In some displays, the phosphors are self emitting, for example, as a result of electroluminescence or cathodoluminescence. In some displays, the phosphors effectively produce desired visualization as a results of back lighting, for example, with excitation from a liquid crystal backlight or light emitting diode backlight. These displays can be used in home electronics or in vehicle displays.

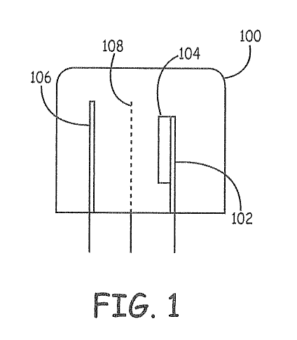

In one representative embodiment, referring to FIG. 1, a display device 100 comprises an anode 102 with a phosphor layer 104 on one side. The phosphor layer faces an appropriately shaped cathode 106, which is the source of electrons used to excite the phosphor. A grid cathode 108 can be placed between the anode 102 and the cathode 106 to control the flow of electrons from the cathode 106 to the anode 102. Further embodiments can be formed by a person of ordinary skill in the art based on the teachings below.

In particular, the silicon nitride-based phosphors can be useful in LED devices. In particular, it can be desirable to have LED devices that emit white light. The diode light source generally emits light in a relatively narrow band. A plurality of phosphors can then be combined to generate white light from the LED. One or more of the phosphors can be a submicron silicon based nitride and/or oxynitride phosphor as described herein. The formation of white light emitting LEDs based on a mixture of phosphors is described further in U.S. Pat. No. 7,291,289 to Gotoh et al., entitled “Phosphor and Production Method of the Same and Light Source and LED Using the Phosphor,” and U.S. Pat. No. 7,345,418 to Nagatomi et al., entitled “Phosphor Mixture and Light Emitting Device Using the Same,” incorporated herein by reference.

The phosphor materials can be combined with a polymer such that the resulting composite material can be used as an encapsulant for a light emitting diode. As used herein, a light emitting diode (LED) includes diode lasers as well as incoherent light emitting diodes. The composites with a phosphor can shift the wavelength of emitted light. A representative configuration of an LED encapsulant is shown in U.S. Pat. No. 6,921,929 to LeBoeuf et al., entitled “Light-Emitting Diode (LED) With Amorphous Fluoropolymer Encapsulant and Lens,” incorporated herein by reference. White light emitting phosphor blends for light emitting diode (LED) devices are described further, for example, in U.S. Pat. No. 6,621,211 to Srivastava et al., entitled “White Light Emitting Phosphor Blends for LED Devices,” incorporated herein by reference. In addition, phosphors that are used in surface electron displays (SED) are described further, for example, in U.S. Pat. No. 6,015,324 to Potter, entitled “Fabrication Process for Surface Electron Display Device With Electron Sink,” incorporated herein by reference.

With respect to additional embodiments, cathode ray tubes (CRTs) have been used for a long time for producing images. CRTs generally use relatively higher electron velocities. Phosphor particles, as described above, can still be used advantageously as a convenient way of supplying particles of different colors, reducing the phosphor layer thickness and decreasing the quantity of phosphor for a given luminosity. CRTs have the general structure as shown in FIG. 1, except that the anode and cathode are separated by a relatively larger distance and steering electrodes rather than a grid electrode generally are used to guide the electrons from the cathode to the anode. The use of phosphors in CRTs is described further, for example, in U.S. Pat. No. 5,523,114 to Tong et al., entitled “Surface Coating With Enhanced Color Contrast for Video Display,” incorporated herein by reference.

Other suitable applications include, for example, the production of flat panel displays. Flat panel displays can be based on, for example, liquid crystals or field emission devices. Liquid crystal displays can be based on any of a variety of light sources. Phosphors can be useful in the production of lighting for liquid crystal displays. Liquid crystal displays can also be illuminated with backlighting from an electroluminescent display. Backlight LCD displays are described further, for example, in U.S. Patent Application 2004/0056990 to Setlur et al., entitled “Phosphor Blends and Backlight Sources For Liquid Crystal Displays,” incorporated herein by reference.

An electroluminescent display also can be used for other display applications such as automotive dashboard and control switch illumination. In addition, a combined liquid crystal/electroluminescent display has been designed. See, Fuh, et al., Japan J. Applied Phys. 33:L870-L872 (1994), incorporated herein by reference.

Alternatively, U.S. Pat. No. 5,651,712, entitled “Multi-Chromic Lateral Field Emission Devices With Associated Displays And Methods Of Fabrication,” incorporated herein by reference, discloses a display incorporating field emission devices having a phosphor layer oriented with an edge (rather than a face) along the desired direction for light propagation. The construction displayed in this patent incorporates color filters to produce a desired color emission rather than using phosphors that emit at desired frequencies. Based on the particles described above, selected phosphor particles can be used to produce the different colors of light, thereby eliminating the need for color filters.

Phosphors are also used in plasma display panels for high definition televisions and projection televisions. These applications require high luminescence. However, standard phosphors generally result in low conversion efficiency. Thus, there is significant heat to dissipate and large energy waste. Use of submicron or nanoscale particles can increase the luminescence and improve the conversion efficiency. Submicron/nanoscale particle based phosphors with high surface area can effectively absorb ultraviolet light and convert the energy to light output of a desired color. Plasma display panels that incorporate phosphor particles are described further in U.S. Pat. No. 6,833,672 to Aoki et al., entitled “Plasma Display Panel and a Method for Producing a Plasma Display Panel,” incorporated herein by reference.

The phosphor particles can be adapted for use in a variety of other devices beyond the representative embodiments specifically described. The submicron/nanoscale phosphor particles described herein can be directly applied to a substrate to produce the above structures. Alternatively, in some embodiments, the phosphor particles can be mixed with a polymer binder such as a curable polymer for application to a substrate. A composition involving a curable binder and the phosphor particles can be applied to a substrate by photolithography, screen printing or other suitable technique for patterning a substrate. Once the composition is deposited at a suitable position on the substrate, the material can be exposed to suitable conditions to cure the polymer. The polymer can be curable by electron beam radiation, UV radiation or other suitable techniques.

### EXAMPLES

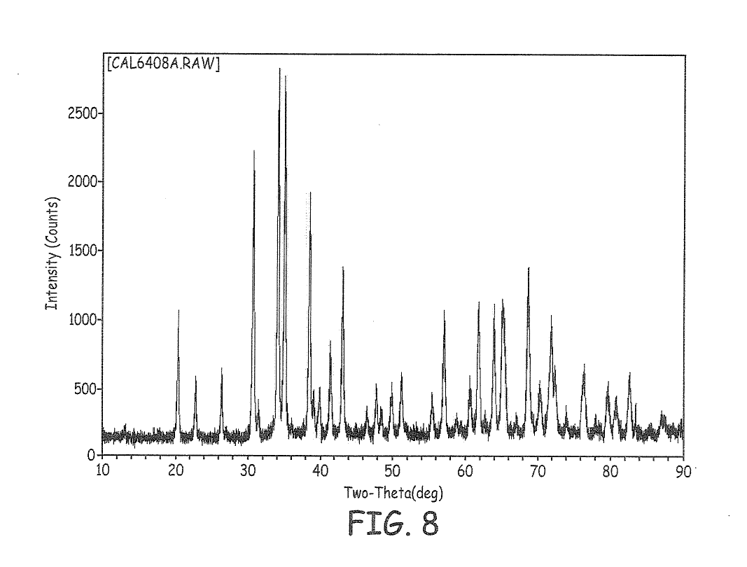

Silicon nitride nanoparticles were produced for use as precursor compositions in processes for phosphor synthesis described in the following examples. Specifically, nanoscale silicon nitride powders with primary particle diameters in the range of 10-20 nm were synthesized using laser pyrolysis with gas phase silane (SiH₄) and ammonia (NH₃) precursors along with inert argon moderating gas. The laser pyrolysis apparatus was essentially as shown in FIG. 8 of U.S. provisional patent application Ser. No. 12/077,076 to Holunga et al. filed Mar. 14, 2008, entitled “Laser Pyrolysis with In-Flight Particle Manipulation for Powder Engineering,” incorporated herein by reference. Inert quenching gas was introduced into the system to cool the product particles.

### Example 1

### Synthesis of Divalent Europium Activated Alkali Earth-Silicon Nitride Submicron Powders

This example demonstrates the synthesis of several europium activated alkali earth-silicon nitride submicron particle powders.

Barium nitride (Ba₃N₂) powders were synthesized using barium metal powder under a nitrogen flow at 550° C. for six hours. Similarly, strontium nitride (Sr₃N₂) was prepared through the reaction of strontium metal powder under a nitrogen flow at 800° C. for 6 hours. These reactions are performed in a tube furnace.

Crystalline submicron powder of M₂₋ₓEuₓSi₅N₈ (0.001≦x≦0.2 and M=Ba or Sr) was prepared in a solid state reaction. Sr₃N₂ or Ba₃N₂, crystalline nano Si₃N₄, prepared by laser pyrolysis as described above, and Eu₂O₃ were weighed, mixed and ground in an agate mortar in a glove box filled with purified nitrogen gas. The mixed powders were transferred into graphite crucibles. Powder filled crucibles were placed into a tube furnace. Samples were heated in the tube furnace at 1200 to 1450° C. for 6 to 10 hours in a reducing atmosphere of nitrogen (N₂) diluted with 4 mole percent H₂. After completing the heating cycle, the samples were gradually cooled down to room temperature in the furnace in the presence of flow gas. The samples were treated with ultrasonication to break the sample clusters to fine particles. After washing with de-ionized water, the fine particles were dried at 120° C. for six hours.

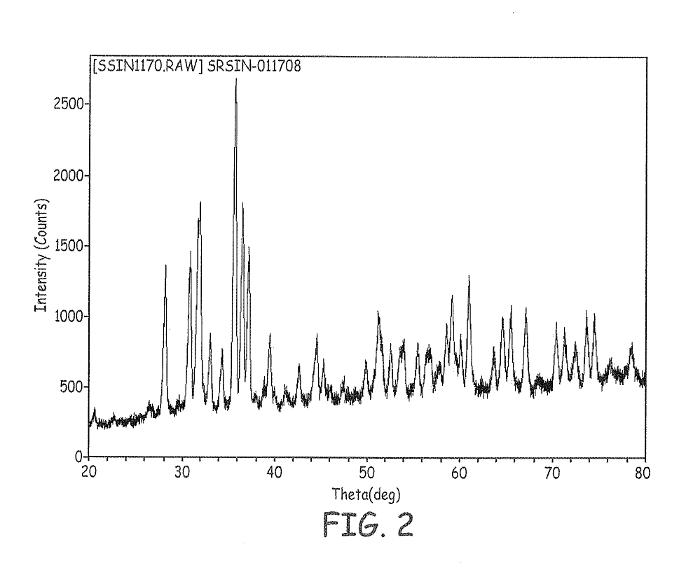

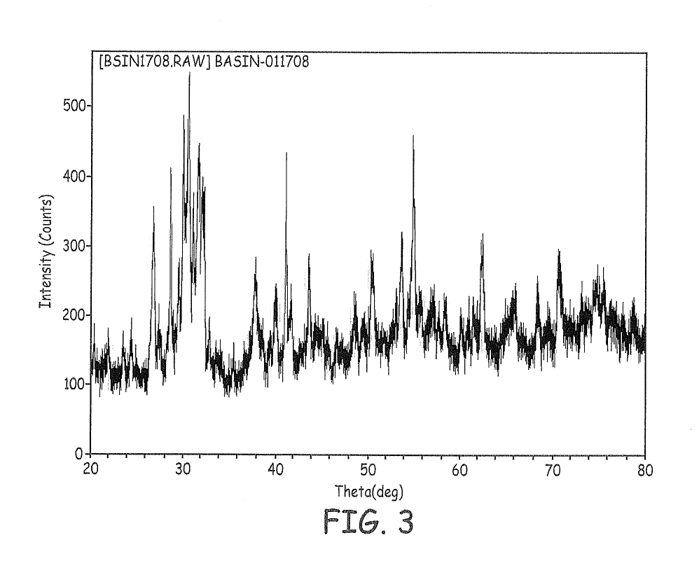

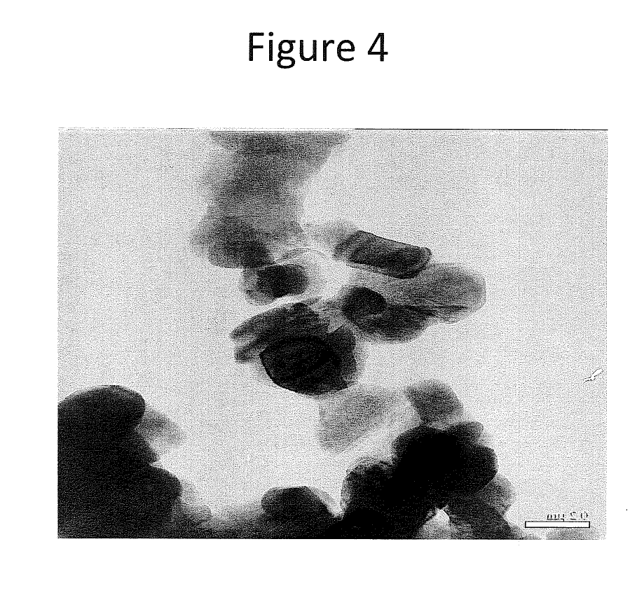

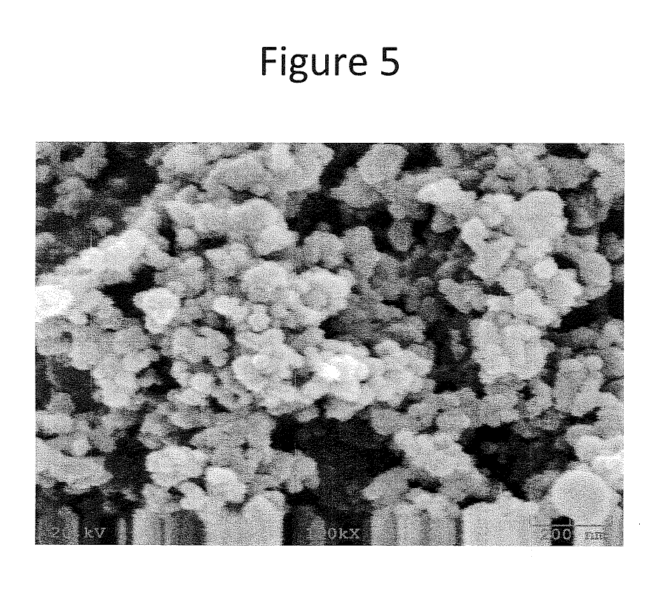

The crystallinity of the samples was characterized using x-ray diffraction (XRD) with a Miniflex Diffractometer from Rigaku. Representative x-ray diffractograms are presented in FIG. 2 for (Sr_{0.98}Eu_{0.02})₂Si₅N₈ and FIG. 3 for (Ba_{0.95}Eu_{0.05})₂Si₅N₈. A transmission electron micrograph (TEM) is shown in FIG. 4 for (Sr_{0.98}Eu_{0.02})₂Si₅N₈, and a scanning electron micrograph (SEM) is shown in FIG. 5 for (Sr_{0.98}Eu_{0.02})₂Si₅N₈.

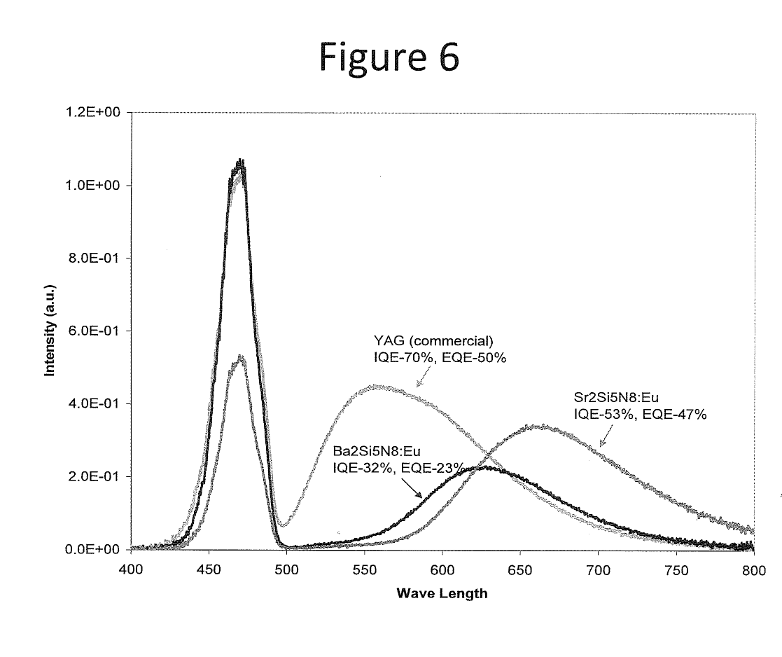

Emission spectra were recorded at room temperature using an Ocean Optics HR4000 spectrophotometer. Powder samples were packed in a custom made sample holder and excited with 450 nm light from Ocean Optics light source (LS-450). Emission spectra are plotted in FIG. 6 for two samples of (Sr_{0.98}Eu_{0.02})₂Si₅N₈ and (Ba_{0.95}Eu_{0.05})₂Si₅N₈ and compared with commercial available sample of YAG-KO (Kasei Optonix); additionally, internal quantum efficiency (IQE) and external quantum efficiency (EQE) of samples were estimated. Specifically, the Ba₂Si₅N₈:Eu sample has IQE of 32%, EQE of 23%, the Sr₂Si₅N₈: Eu sample has IQE of 53% and EQE of 47% compared to the IQE of 70% and EQE of 50% of YAG.

### Example 2

### Synthesis of Divalent Europium Activated Alkali Earth-Silicon Oxynitride Submicron Powders

This example demonstrates the synthesis of several europium activated alkali earth-silicon oxynitride submicron particle powders.

Crystalline submicron powder of M₁₋ₓEuₓSi₂O₂N₂ (0.001≦x≦0.2 and M=Ba, Sr or Ca) were prepared in a solid state reaction. A two step synthesis was used. First, a stoichiometric mixture of SrCO₃, BaCO₃, CaCO₃ or a combination of them and SiO₂ was mixed thoroughly in mortar and pestle and transferred into an alumina boat and fired at 1000 to 1200° C. at a rate of heating from 2 to 4° C. per mint for 2 to 4 hours. The firing was repeated to ensure complete reaction to form a M₂SiO₄ silicate intermediate; samples were grinded between firings using a mortar and pestle. The reaction was carried out in reducing atmosphere by flowing 2-4 L/min of forming gas, which was composed of nitrogen (N₂) diluted with 4 mole percent H₂.

After cooling, the samples were ground and then mixed with required amount of nano Si₃N₄ and Eu₂O₃ in a mortar and pestle to form a mixture. The nano-Si₃N₄ was synthesized by laser pyrolysis as described above and was a mixture of crystalline and amorphous silicon nitride. The Eu₂O₃ level can be 5, 15, or 20%. The mixture was transferred into an alumina boat to be heated in a tube furnace. Small quantity e.g. 1-2% of flux material such as ammonium chloride or ammonium fluoride was added into the mixture to improve the morphology of the final product and reduce the reaction temperature. The mixture was calcinated at 1300 to 1400° C. for 4 to 6 hours in a reducing atmosphere of nitrogen (N₂) diluted with 4 mole percent H₂. The firing was repeated to ensure complete reaction; samples were grinded between firings using a mortar and pestle. Cooling and washing processes are similar to the corresponding steps as described in Example 1.

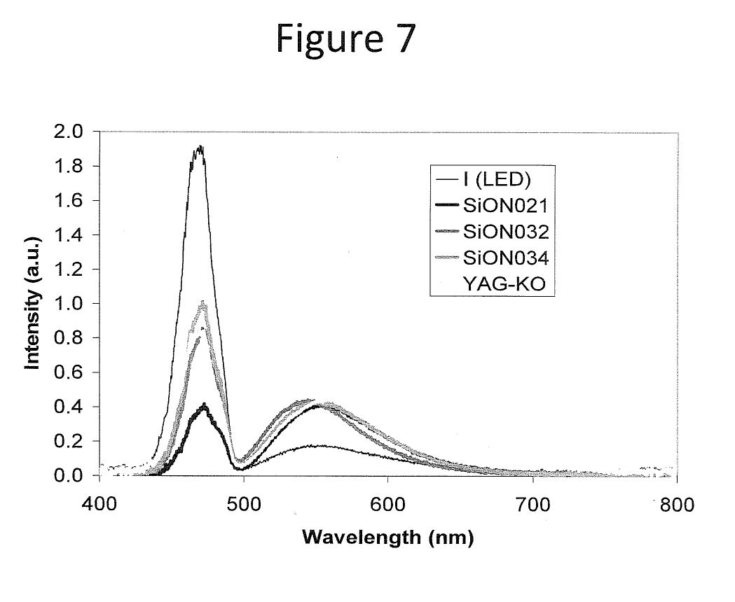

Emission spectra are plotted in FIG. 7 for samples SiON021, SiON032, SiON034 in comparison to commercially available reference YAG-KO (Kasei Optonix). SiON021 was synthesized using quartz and crystalline nano-Si₃N₄ (synthesized by laser pyrolysis) at 15% Eu dopant level. SiON032 and SiON034 were synthesized using amorphous nano-SiO2 (synthesized by laser pyrolysis) and crystalline nano-Si₃N₄ (synthesized by laser pyrolysis) at 5% and 25% Eu dopant level, respectively. The SiON021 sample had an IQE of 31% and EQE of 27%. The SiON032 sample had an IQE of 35% and EQE of 22%. The SiON034 sample had an IQE of 38% and EQE of 21%. In comparison, commercial YAG-KO had an IQE of 70%, and EQE of 50%.

### Example 3

### Synthesis of Divalent Europium Activated Alkali Earth-Aluminum Silicon Oxynitride Submicron Powders

This example demonstrates the synthesis of several europium activated alkali earth-aluminum silicon oxynitride submicron particle powders.

Crystalline submicron powder of M₁₋ₓEuₓAl₃Si₉ON₁₅ (0.001≦x≦0.2 and M=Ba, Sr or Ca) were prepared in a controlled atmosphere by solid state reaction. A stoichiometric mixture of SrCO₃, BaCO₃, CaCO₃ or combination thereof, AlN, Al₂O₃, Si₃N₄, and Eu₂O₃ were mixed thoroughly in mortar and pestle in a glove box filled with N₂. The amount of Al₂O₃ and alkaline earth carbonates used was determined by the quantity of oxygen required to balance the oxygen content in the final formula. The reaction mixture was then transferred into a graphite crucible. The graphite crucible filled with mixed starting chemicals was transferred to a N₂ filled container, which was transferred into a tube furnace maintained under a flow of N₂. The tube furnace was fired at 1400 to 1700° C. at a rate of heating from 2 to 4° C. per minute for 4 to 8 hours in reducing atmosphere by flowing 2-4 L/min of forming gas and 2-4 L/min of pure N₂ gas. The forming gas was composed of 4% H₂ and 96% N₂. Subsequent cooling and washing processes were similar to the corresponding steps as described in Example 1.

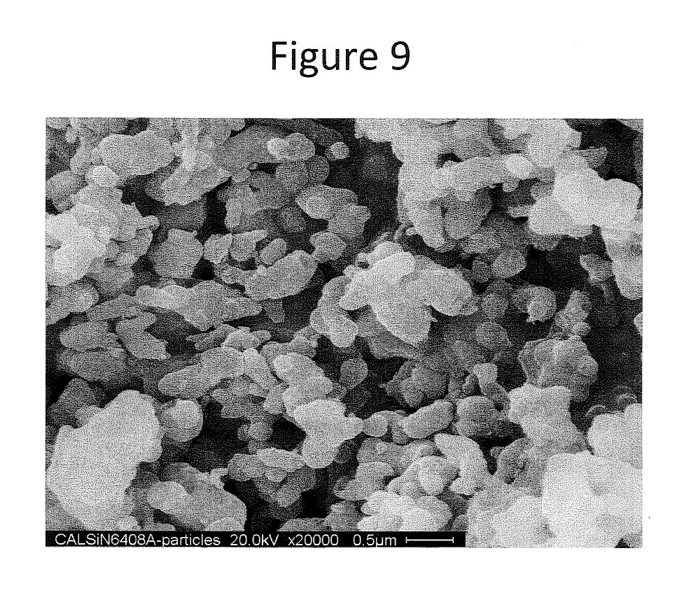

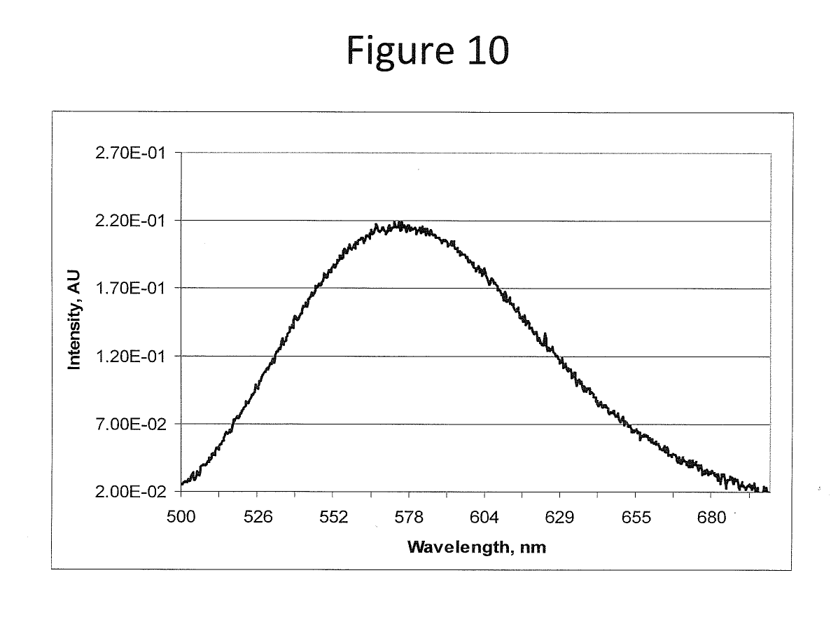

These fine powders obtained were characterized by XRD, SEM and PL measurements using the conditions outlined in Example 1. FIG. 8 is X-ray diffractogram of representative Ca_{0.94}Eu_{0.1}Al₃Si₉ON₁₅ phosphor. A scanning electron micrograph from same sample group Ca_{0.94}Eu_{0.06}Al₃Si₉ON₁₅ is shown in FIG. 9. Emission spectrum recorded from one of the phosphor samples from the same group Ca_{0.94}Eu_{0.06}Al₃Si₉ON₁₅ is shown in FIG. 10.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

We claim:

1. A collection of crystalline metal silicon nitride/oxynitride particle having an average primary particle diameter of no more than about 250 nm and comprising a dopant activator element at no more than about 10 mole percent relative to the total metal plus silicon molar content, wherein the particles have an IQE of at least about 25%.

2. The collection of crystalline metal silicon nitride/oxynitride particles of claim 1 wherein average primary particle size is no more than about 200 nm.

3. The collection of crystalline metal silicon nitride/oxynitride particles of claim 1 wherein the particles have an IQE value from about 35% to about 75%.

4. The collection of crystalline metal silicon nitride/oxynitride particles wherein of claim 1 the crystalline metal silicon nitride/oxynitride comprise a metal silicon nitride.

5. The collection of crystalline metal silicon nitride/oxynitride particles of claim 1 wherein the crystalline metal silicon nitride/oxynitride comprise a composition represented by the formula LₓSi_{y}N_{((2/3)x+(4/3)y)}:R, where L is Mg, Ca, Sr, Ba, Zn or combinations thereof, 0.5≦x≦3, 1.5≦y≦8 and R is a rare earth activator.

6. The collection of crystalline metal silicon nitride/oxynitride particles of claim 1 wherein the crystalline metal silicon nitride/oxynitride comprises a composition represented by the formula L_{1-z}MSiN₃:R_{z}, where L is a divalent metal element, M is a trivalent metal element, R is a rare earth element and 0.0001≦z≦0.1.

7. The collection of crystalline metal silicon nitride/oxynitride particles of claim 1 wherein the crystalline metal silicon nitride/oxynitride particles comprise a metal silicon oxynitride composition.

8. The collection of crystalline metal silicon nitride/oxynitride particles of claim 1 comprises a composition represented by the formula LₓSi_{y}O_{z}N_{((2/3)x+(4/3)y+(2/3)z}:R, where L is Mg, Ca, Sr, Ba, Zn, or a combination thereof, R is a rare earth dopant, 0.5≦x≦3, 1.5≦y≦8 and 0<z≦3.

9. The collection of crystalline metal silicon nitride/oxynitride particles of claim 1 wherein the crystalline metal silicon nitride/oxynitride particles comprise a metal aluminum silicon oxynitride composition.

10. The collection of crystalline metal silicon nitride/oxynitride particles of claim 1 wherein the dopant element comprises a rare earth element.

11. A method for synthesizing metal silicon nitride particles, the method comprising heating a blend of metal nitride precursor particles and silicon nitride precursor particles to form product crystalline metal silicon nitride particles wherein the silicon nitride precursor particles have an average primary particle size of no more than about 100 nm to form product particles having an average primary particle size of no more than about 1 micron.

12. The method of claim 11 wherein the heating is performed at a temperature of no more than about 1600° C.

13. The method of claim 11 wherein the metal nitride precursor particles have an average primary particle size of no more than about 100 nm.

14. The method of claim 11 wherein the silicon nitride precursor particle have an average primary particle diameter of no more than about 25 nm.

15. The method claim 11 wherein the silicon nitride precursor particles have an average primary particle diameter of no more than about 50 nm and the metal nitride precursor particles have an average primary particle size of no more than about 50 nm.

16. A method for synthesizing metal aluminum silicon oxynitride particles, the method comprising heating a blend of metal composition precursor particles, aluminum composition precursor particles and silicon composition precursor particles to form, product crystalline metal silicon aluminum oxynitride particles, wherein metal composition precursor particles comprise a metal oxide, a metal nitride, a metal oxynitride, a metal carbonate or combinations thereof, the aluminum composition precursor particles comprise Al₂O₃, AlN, AlNₓO_{(1-x)3/2} or mixtures thereof, the silicon composition precursor particles comprise Si₃N₄, SiO₂, SiN_{(1-x)4/3}O₂ₓ or mixtures thereof, wherein the silicon composition precursor particles have an average primary particle size of no more than about 100 nm, and wherein the product metal aluminum silicon oxynitride particles have an average primary particle diameter of no more than about 1 micron.

17. The method of claim 16 wherein the metal composition precursor particles and the aluminum composition precursor particles each have an average primary particle diameter of no more than about 100 nm and wherein the heating is performed at a maximum temperature from about 800° C. to about 1600° C. for at least about 15 minutes.

18. The method of claim 16 wherein the precursor particles of each composition have an average particle diameter of no more than 50 nm.

19. The method of claim 16 wherein the aluminum precursor particles comprise Al₂O₃ and the metal precursor composition particles comprise a metal carbonate.

20. A method for synthesizing metal silicon nitride/oxynitride particles, the method comprising heating a blend of metal composition precursor particles and silicon composition precursor particles to form crystalline metal silicon nitride/oxynitride particles, wherein the silicon composition precursor particles comprise Si₃N₄, SiO₂, SiN_{(1-x)4/3}O₂ₓ, 0<x<1 or mixtures thereof and have an average particle diameter of no more than about 100 nm and wherein the metal composition precursor particles comprise a metal oxide, a metal nitride, a metal oxynitride, a metal carbonate or combinations thereof and have an average particle diameter of no more than about 100 nm and the metal silicon nitride/oxynitride product particles have an average particle size of no more than about 1 micron.

21. The method of claim 20 wherein the silicon composition precursor particles have an average particle size of no more than about 50 nm and the metal composition precursor particles have an average particle diameter of no more than about 50 nm.

22. The method of claim 20 wherein the metal composition precursor particles comprise a metal carbonate.
